(19) United States
(12) Patent Application Publication
(10) Pub. No.: US 2023/0238791 A1
(43) Pub. Date: Jul. 27, 2023

(54) PROTECTION MEMBER AND PROTECTION METHOD

(71) Applicant: NIPPON TELEGRAPH AND TELEPHONE CORPORATION, Chiyoda-ku, Tokyo (JP)

(72) Inventors: Daisaku NISHIYAMA, Musashino-shi, Tokyo (JP); Kenji HIYOSHI, Musashino-shi, Tokyo (JP); Koji ITASAKA, Musashino-shi, Tokyo (JP)

(73) Assignee: NIPPON TELEGRAPH AND TELEPHONE CORPORATION, Chiyoda-ku, Tokyo (JP)

(21) Appl. No.: 18/246,677

(22) PCT Filed: Oct. 7, 2020
(86) PCT No.: PCT/JP2020/038036

§ 371 Date: Mar. 27, 2023

(51) Int. Cl. H02G 9/06; F16L 3/26

(52) U.S. Cl. CPC H02G 9/06; F16L 3/26

(57) ABSTRACT

A protective member (1) for protecting the cables (9) includes an inclined steel material (3) having an inclined upper surface (S) to a horizontal surface (H) above the cable (9) and an outer pipe (7) which is a buried pipe for accommodating the cables (9) and the inclined steel material (3).

### TECHNICAL FIELD

The present invention relates to a protective member and a protective method.

### BACKGROUND ART

it is known that a buried pipe for accommodating cables is used when various cables such as optical fibers and power transmission lines are buried in the ground. When the buried pipe is buried in the ground under a road or the like to form the buried pipe line, in a shallow layer section in which soil covering as a depth from the ground surface to the buried pipe cannot be sufficiently secured, there is a high risk that the buried pipe line is damaged from an excavating machine and the like such as a backhoe, a breaker or a cutter due to road construction or the like.

In order to prevent the damage of the buried pipe line in the shallow layer section, it is known that a sign sheet indicating that the buried pipe is buried is used, or an iron plate, a ceramic plate, or a metal plate is installed between the ground surface and the buried pipe (PTL 1 to 3).

### CITATION LIST

### Patent Literature

[PTL 1] Japanese Patent Application Publication No. 2001-355758

[PTL 2] Japanese Patent Application Publication No. 2007-143355

[PTL 3] Japanese Patent Application Publication No. 2015-180166

### SUMMARY OF INVENTION

### Technical Problem

However, in the conventional structure, a suitable space is required above the buried pipe, and since it is difficult to secure the separation from the ground surface to the buried pipe due to a structure of terrain, a stratum, or the like, there is a case where the buried pipe line cannot be protected appropriately.

An object of the present disclosure is to provide a protective member and a protective method capable of appropriately protecting a buried pipe line even when it is difficult to secure separation from a ground surface to a buried pipe.

### Solution to Problem

A protective member according to one embodiment is a protective member for protecting cables, and includes an inclined steel material having an upper surface inclined to a horizontal surface above the cable, and an outer pipe that is a buried pipe for accommodating the cables and the inclined steel material.

A protective method according to one embodiment is a protective method for protecting cables, and includes steps of arranging the inclined steel material having the upper surface inclined to the horizontal surface above the cable, and accommodating the cables and the inclined steel material in the outer pipe that is the buried pipe.

### Advantageous Effects of Invention

According to the present disclosure, even when it is difficult to secure separation from the ground surface to the buried pipe, the buried pipe line can be appropriately protected.

### BRIEF DESCRIPTION OF DRAWINGS

FIG. 1 is a cross-sectional view showing a configuration example of a protective member according to an embodiment of the present disclosure.

FIG. 2A is a cross-sectional view showing an example of the positional relationship among an inner pipe, an inclined steel material, and an outer pipe.

FIG. 2A is a cross-sectional view showing an example of the positional relationship among an inner pipe, an inclined steel material, and an outer pipe.

FIG. 2A is a cross-sectional view showing an example of the positional relationship among an inner pipe, an inclined steel material, and an outer pipe.

FIG. 2A is a cross-sectional view showing an example of the positional relationship among an inner pipe, an inclined steel material, and an outer pipe.

FIG. 2A is a cross-sectional view showing an example of the positional relationship among an inner pipe, an inclined steel material, and an outer pipe.

FIG. 2A is a cross-sectional view showing an example of the positional relationship among an inner pipe, an inclined steel material, and an outer pipe.

FIG. 3A is a cross-sectional view showing an example of the inner pipe configured as a split pipe.

FIG. 3A is a cross-sectional view showing an example of the inner pipe configured as a split pipe.

FIG. 4A is a cross-sectional view showing an example of the outer pipe configured as the split pipe.

FIG. 4A is a cross-sectional view showing an example of the outer pipe configured as the split pipe.

FIG. 5 is a cross-sectional view showing another configuration example of the protective member according to the embodiment of the present disclosure.

FIG. 6 is a flowchart showing a procedure of the protective method according to the embodiment of the present invention.

### DESCRIPTION OF EMBODIMENTS

Hereinafter, as embodiment of the present disclosure will be described with reference to drawings. In the drawings, the same or corresponding parts are denoted by the same reference numerals. In the description of the present embodiment, description of the same or corresponding parts will be appropriately omitted or simplified.

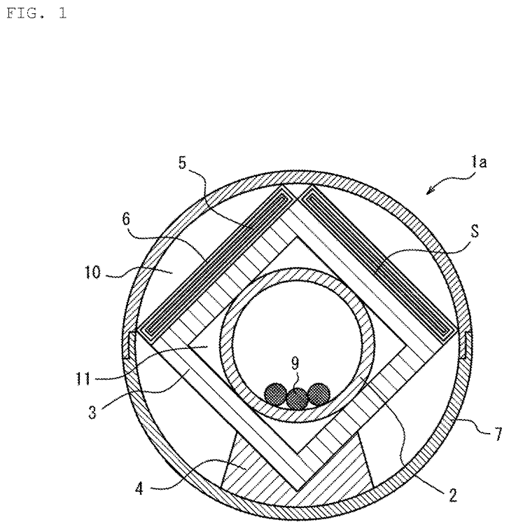

The present disclosure makes it possible to reduce a protective space more than a conventional configuration by constructing a protective structure in a buried pipe, and protect the buried pipe even when it is difficult to secure a separation (a depth) from a road surface. FIG. 1 is the cross-sectional view showing a configuration example of the protective member 1a according to the embodiment of the present disclosure. The protective member la protects cables 9 buried in the ground. The protective member 1a includes an inner pipe 2, an inclined steel material 3, a fixing jig 4, a fiber sheet 5, a sheet protective material 6 and an outer pipe 7.

The inner pipe 2 is the buried pipe for accommodating the cables 9. In the example shown in FIG. 1, the inner pipe 2 has a circular cross section. By providing the inner pipe 2 as another buried pipe in addition to the inclined steel material 3, the fixing jig 4, the fiber sheet 5, the sheet protective material 6, and the outer pipe 7, impact from an excavating machine and the like such as a backhoe, a breaker or a cutter is not directly transmitted to the cables 9, and the cables 9 are protected. The inner pipe 2 can be constituted of an arbitrary material, for example, may be constituted of a synthetic resin material such as hard vinyl chloride and polyethylene containing calcium carbonate, metal, ceramic, or the like.

The inclined steel material 3 is a steel material having an upper surface S inclined to the horizontal surface above the cable 9 and the inner pipe 2 for accommodating the cables 9. In FIG. 1, a hollow part 11 having a rhombic cross section and accommodating the inner pipe 2 is provided. The inclined steel material 3 secures a space 10 between the outer pipe 7 and the inclined steel material and protects the cables 9 by preventing an impact from the excavating machine or the like from being directly transmitted to the inner pipe 2. The inclined steel material 3 can be constituted of any high-grade material, and may be constituted of, for example, a metal such as steel, ceramic or the like.

Since the upper surface S of the inclined steel material 3 is above the inner pipe for accommodating the cables 9, the cables 9 or the inner pipe can be prevented from directly receiving the impact from an upper part by the excavating machine or the like. Since the inclined steel material 3 has the upper surface S inclined to the horizontal surface, even if a cutting edge of the breaker, the cutter or the like is brought into contact with the inclined steel material 3, the cutting edge is deflected to prevent intrusion of the cutting edge into the inner pipe 2 and the cables 9. As shown in FIG. 1, the inclined steel member 3 surrounds the inner pipe 2, so that it is difficult to transmit the impact from the excavating machine or the like to the inner pipe 2, and the impact is released to the lower side. Further, since the inclined steel material 3 has the rhombic cross section, the space 10 can be secured between the inclined steel material 3 and the outer pipe 7, and the function of the fiber sheet 5 having high strength described later is assisted.

The fixing jig 4 is a member for fixing the inclined steel material 3 to the outer pipe 7. The fixing jig 4 prevents the inclined steel material 3 from largely moving in the buried pipe line formed by the outer pipe 7. By providing the fixing jig 4, the inclined steel material 3 can be stably installed in the outer pipe 7. Accordingly, by fixing the inclined steel material 3 by the fixing jig 4, a load such. as impact and vibration to the inner pipe 2 and the cables 9 accommodated in the inner pipe 2 due to movement of the inclined steel material 3 can be reduced. The fixing jig 4 is provided not only in the whole buried pipe line but only in the connection part and the like of the buried pipe line, so that the installation cost can be reduced.

The fiber sheet 5 is a sheet-like fiber having high strength arranged on the upper surface S of the inclined steel material 3. The fiber sheet 5 prevents the cables 9 from being cut by entangling a rotary paving cutter with the fiber. When the fiber sheet 5 is fixed on the inclined steel material 3, the fiber sheet 5 is easily cut when the rotary paving cutter comes into contact with the inclined steel material 3. Therefore, when a rotary cutter comes into contact with the fiber sheet 5, the space 10 may be secured between the inclined steel material 3 and the outer pipe 7 so that the fiber sheet 5 can he moved so that the fiber is entangled with the cutter. The fiber sheet 5 can be constituted of any fiber having high strength, and may be constituted of, for example, aramid fiber or synthetic fiber mixed with aramid fiber.

The sheet protective material 6 is a member for preventing water absorption of the fiber sheet 5 and covering the surface of the fiber sheet 5. When the fiber sheet 5 absorbs water, the fiber sheet 5 is hardly entangled with the cutter intruded from the ground surface, and is easily cut by the cutter. The sheet protective material 6 wraps the fiber sheet 5 to prevent the fiber sheet 5 from absorbing water, thereby preventing the strength of the fiber sheet 5 from being lowered by water absorption. Further, the sheet protective material 6 is formed of a slippery material, so that the excavating machine or the like can be slid on the fiber sheet 5 even if the excavating machine or the like such as the cutter or the breaker intrudes. Therefore, the sheet protective material 6 assists a function of deflecting the edge of a cutter or the like by the inclined upper surface S of the inclined steel material 3. The sheet protective material 6 can be constituted of any material which does not allow water to pass through, and may be constituted of, for example, polyvinylidene chloride or low density polyethylene.

The outer pipe 7 is the buried pipe accommodating the cables 9, the inner pipe 2 for accommodating the cables 9, the inclined steel material 3, the fixing jig 4, the fiber sheet 5, and the sheet protective material 6. In the example shown in FIG. 1, the outer pipe 7 has a circular cross section. When the cables 9 is buried in the ground, the outer pipe 7 protects the cables 9, the inner pipe 2 for accommodating the cables 9, the inclined steel material 3, the fixing jig 4, the fiber sheet 5, and the sheet protective material 6. In the example shown in FIG. 1, the outer pipe 7 has a split pipe structure in which an upper half part and a lower half part can be separated from each other. By forming the outer pipe 7 into such the split pipe structure, the installation of the protective member 1a is facilitated, and partial replacement is made possible even at the time of repair. Accordingly, the outer pipe 7 has the split pipe structure, and thereby workability can be improved. The outer pipe 7 can also be constituted of an arbitrary material like the inner pipe 2, and for example, may be constituted of the synthetic resin material such as polyethylene hard vinyl chloride and polyethylene containing calcium carbonate, the metal, the ceramic or the like.

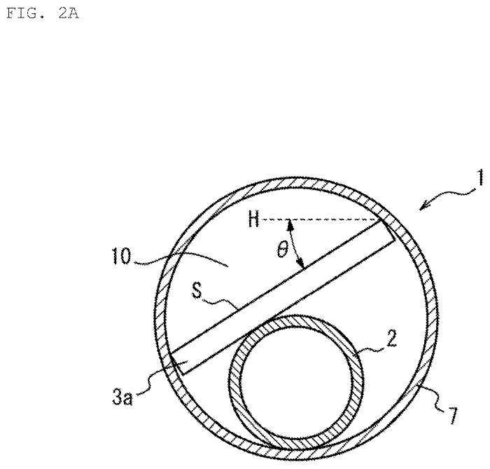

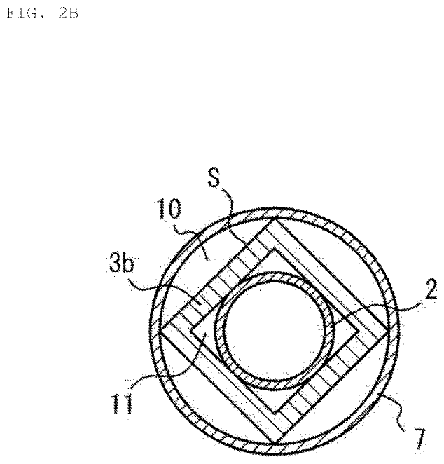

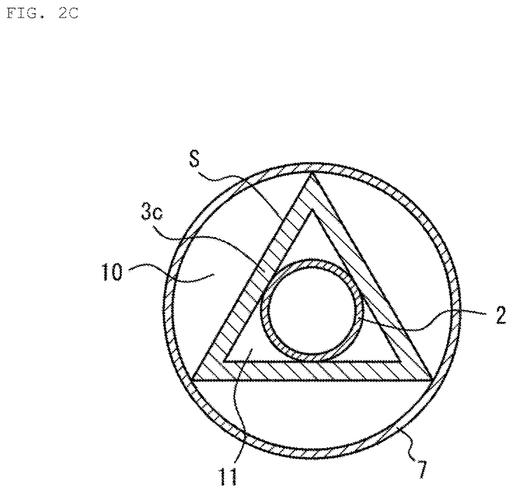

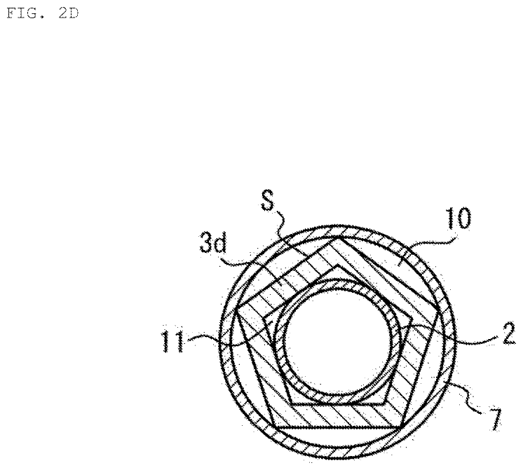

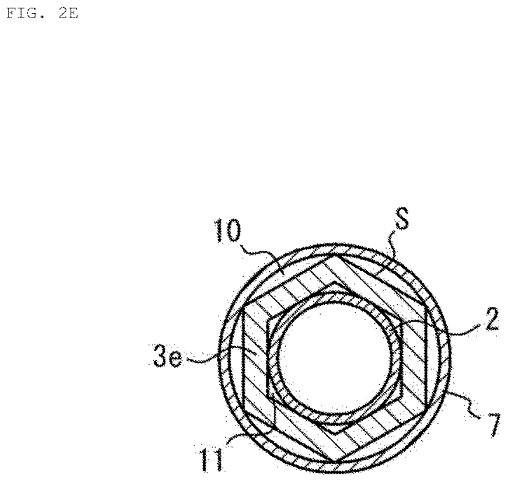

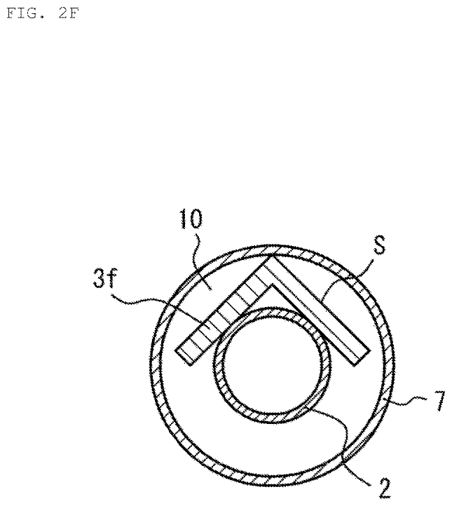

In the protective member 1a shown in FIG. 1, the inclined steel material 3 has the rhombic cross section, but the shape of the inclined steel material 3 is not limited to the one having the rhombic cross section if it has the upper surface S inclined to the horizontal surface above the cable 9. With reference to FIG. 2A to FIG. 2F, various shapes of inclined steel materials 3 are described. FIG. 2A to FIG. 2F are cross-sectional views showing an example of the positional relationship among the inner pipe 2, the inclined steel material 3, and the outer pipe 7. In FIG. 2A to FIG. 2F, only the inner pipe 2, the inclined steel material 3 and the outer pipe 7 are shown, and description of other components of the protective member 1 is omitted.

FIG. 2A shows a cross section of the protective member 1 having the inclined steel material 3a having a flat plate shape.

Since the inclined steel material 3 is located above the inner pipe 2 accommodating the cables 9, the cables 9 or the inner pipe 2 can be prevented from directly receiving the impact from the upper part by the excavating machine or the like. In FIG. 2A, the upper surface S of the inclined steel material 3a is inclined at an angle θ (0°<θ<90°) with respect to the horizontal surface H. Therefore, even if the cutter edge of the breaker, the cutter or the like comes into contact with the inclined steel material 3, the cutter edge is deflected and the intrusion of the cutter edge into the inner pipe 2 can be prevented. Further, since the inclined steel material 3a extends in the outer pipe 7, the space 10 can be secured between the inclined steel material 3a and the outer pipe 7, and the function of the fiber sheet 5 is assisted. Further, since the inclined steel material 3a having the flat plate shape has a simple structure, the manufacturing cost and the labor for installation can be reduced.

FIG. 2B to FIG. 2E show the cross sections of the protective member 1 having an inclined steel material 3b to 3e having a polygonal cross section and having the hollow part 11 for accommodating the inner pipe 2. The inclined steel material 3b of FIG. 2B has a cross section of a square-shaped (a rhombic). The inclined steel material 3c of FIG. 2C has a triangular cross section. The inclined steel material 3d in FIG. 2D has pentagonal cross section. The inclined steel material 3e of FIG. 2E has a hexagonal cross section. Each of the inclined steel materials 3b to 3e has an upper surface S inclined to the horizontal surface above the inner pipe 2 accommodating the cables 9, and the inner pipe 2 is accommodated in the hollow part 11, so that the same function as the inclined steel material 3 described with reference to FIG. 1 is exhibited.

FIG. 2F shows a cross section of the protective member 1 including the inclined steel material 3f having a chevron-shaped cross section. Since the inclined steel material 3f has an upper surface S inclined to the horizontal surface above the inner pipe 2 accommodating the cables 9, the inclined steel material 3f has the same function as the inclined steel material 3a described with reference to FIG. 2A.

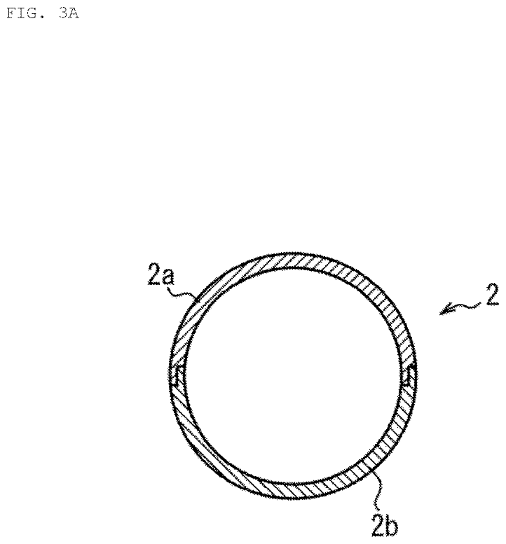

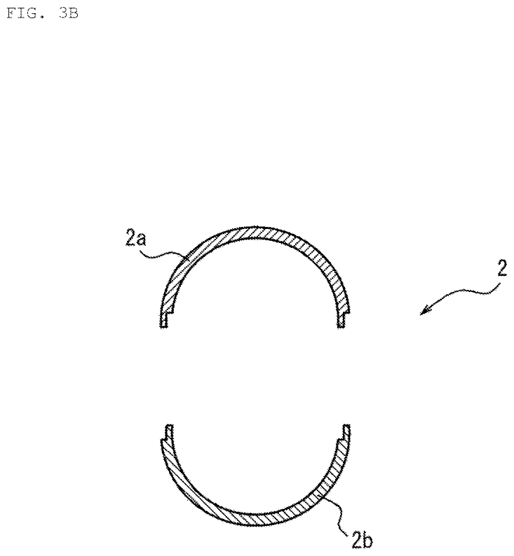

Although FIG. 1 shows an example in which the outer pipe 7 has the split pipe structure, the inner pipe 2 may also have the split pipe structure. FIGS. 3A and 3B are cross-sectional views showing an example of the inner pipe 2 constituted as the split pipe. An upper part 2a and a lower part 2b of the inner pipe 2 can be separated from each other.

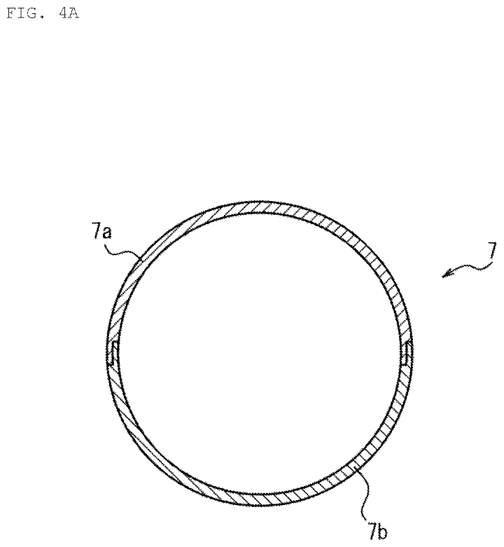

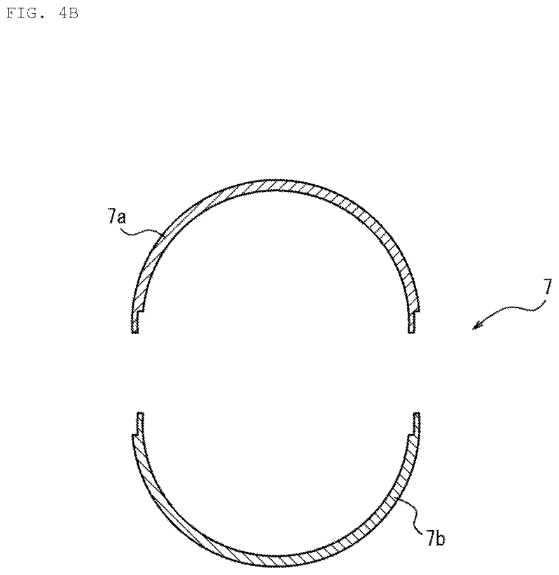

FIGS. 4A and 4B are cross-sectional views showing an example of the outer pipe 7 constituted as the split pipe. The outer pipe 7 can be separated into an upper part 7a and a lower part 7b. By forming the inner pipe 2 and the outer pipe 7 into such the split pipe structure, the installation of the protective member 1a is facilitated, and partial replacement is made possible even in the case or repair, so that workability can be improved. The split pipe structure of the inner pipe 2 and the outer pipe 7 may have not only a structure in which the upper part and the lower part of the buried pipe can be separated, but also another structure as long as the accommodated object can be easily taken in and out. For example, the split pipe structure of the inner pipe 2 and the outer pipe 7 may be a structure in which the buried pipe can be separated on a vertical surface. Further, the split pipe structure of the inner pipe 2 and the outer pipe 7 may be separable in all parts of the buried pipe, but may be separable only in a part of the buried pipe.

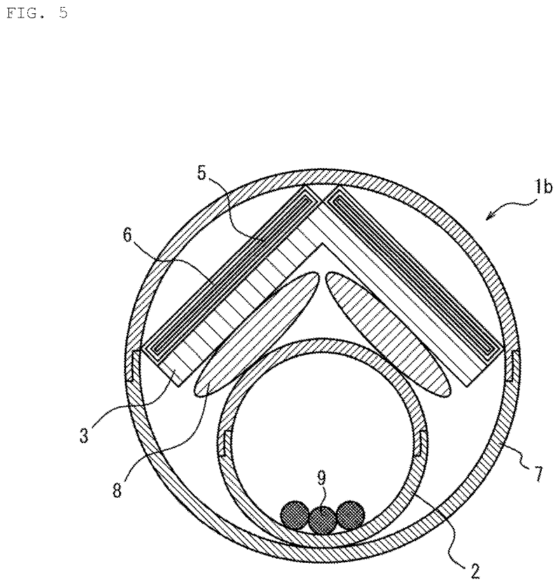

FIG. 5 is a cross-sectional view showing a configuration example of a protective member 1b according to an embodiment of the present disclosure. The protective member 1b includes the inner pipe 2, the inclined steel material 3, the fiber sheet 5, the sheet protective material 6, the outer pipe 7 and a buffer material 8. Among the components of the protective member 1b, those common to the protective member 1a are given the same reference numerals, and detailed description thereof is omitted.

In the protective member 1b, unlike the protective member 1a, not only the outer pipe 7 but also the inner pipe 2 have the split pipe structure, and the installation is facilitated. The inclined steel material 3 has the chevron-shaped cross section of an equal side. In the protective member 1b, the fixing jig 4 for fixing the inclined steel material 3 to the outer pipe 7 is provided not only in the whole buried pipeline but also only in the connection part of the buried pipeline or the like in order to reduce the cost. FIG. 5 shows a cross-sectional view of the protective member 1b at a part where the fixing jig 4 is not provided.

The buffer material 8 is a member for relaxing the impact to the inner pipe 2 from the excavating machine or the like to prevent the inner pipe 2 and the cables 9 from being damaged. The buffer material 8 is arranged between the inner pipe 2 and the inclined steel material 3, and can absorb the impact from the upper part. The buffer material 8 may be fixed to at least one of the inner pipe 2 and the inclined steel material 3 in order to keep the inclination of the inclined steel material 3 against the impact from the upper part. The buffer material 8 can be constituted of any material absorbing impact, and may be constituted of, for example, rubber, sponge, or the like. The buffer material 8 may be provided not only to the inclined steel material 3 having the chevron-shaped. cross section but also to the inclined steel material 3 having an arbitrary shape.

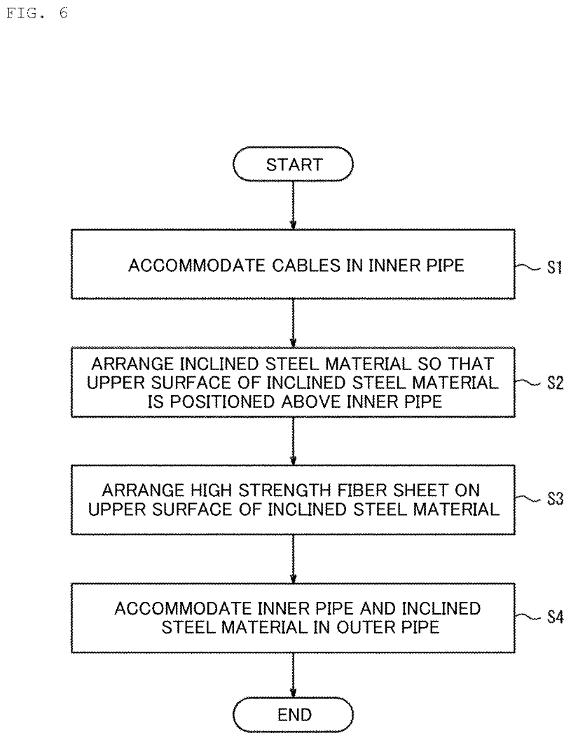

FIG. 6 is a flowchart showing the procedure of the protective method according to the embodiment of the present disclosure. In the protective method according to the present embodiment, a protective structure for protecting the cables 9 is constructed, so that a protective space can be reduced more than the conventional structure, and the buried pipe can be protected even when it is difficult to secure the separation (the depth) from the road surface.

In a step S1, the cables 9 is accommodated in the inner pipe 2. As the inner pipe 2, one having the split pipe structure may be used.

In a step S2, the inclined steel material 3 is arranged so that the upper surface S of the inclined steel material 3 is positioned above the inner pipe 2. When the inclined steel material 3 has the hollow part 11 shown in FIG. 2B to FIG. 2E, the inner pipe 2 for accommodating the cables 9 is passed through the hollow part 11 of the inclined steel material 3. The buffer material 8 may be arranged between the inclined steel material 3 and the inner pipe 2.

In a step S3, the fiber sheet 5 having high strength is arranged on the upper surface S of the inclined steel material 3. The surface of the fiber sheet 5 may be covered with the sheet protective material 6.

In a step S4, the inclined steel material 3 on which the inner pipe 2 for accommodating the cables 9 and the fiber sheet 5 are arranged are accommodated in the outer pipe 7. When the inclined steel material 3 is accommodated, the inclined steel material 3 may be fixed to the outer pipe 7 by the fixing jig 4. As the outer pipe 7, one having the split pipe structure may be used.

The protective member 1 having the protective structure for protecting the cables 9 can be constituted by the above steps. In this case, the order of the steps described above may be changed.

In each embodiment of the present disclosure, by constructing a protective structure in the outer pipe 7 of the protective member 1, it is not necessary to provide another member between the ground surface and the outer pipe 7, and the cables 9 can be protected from the excavating machine or the like. Therefore, the protective member 1 can be applied even when it is difficult to secure separation from the road surface, and space saving of the upper part of the buried pipe can be achieved.

In the protective member 1, the inclined steel material 3 having the upper surface S inclined to the horizontal surface H is installed above the inner pipe 2 accommodating the cables in the outer pipe 7. Thus, the protective member 1 can protect the cables 9 by deflecting the impact from the upper part and preventing the impact from being directly transmitted to the inner pipe 2 for accommodating the cables 9. Further, the fiber sheet 5 having high strength may be arranged on the upper surface of the inclined steel material 3. The cables 9 can be protected from the paving cutter or the like by entangling the fiber sheet 5 having high strength with the paving cutter or the like. Therefore, each embodiment of the present disclosure can appropriately protect the buried pipe line even if it is difficult to secure separation from the ground surface to the buried pipe with a large risk of damage due to the excavating machine or the like.

Further, by constituting at least either the inner pipe 2 or the outer pipe 7 into the split pipe structure, not only the protective member 1 can be easily newly installed but also the accommodated object can be partially replaced at the time of repair. Therefore, workability is improved by using the inner pipe 2 or the outer pipe 7 having the split pipe structure.

The present disclosure is not limited to the embodiment described above. Instead of executing a plurality of steps of processing described in the flowchart in a time-series manner according to the described order, the steps of processing may be executed in parallel or a different order depending on the processing ability of a device that executes the processing or as necessary, for example. Besides this, the present disclosure may be changed without departing from the spirit of the present disclosure.

### REFERENCE SIGNS LIST

1, 1a, 1b Protective member

2 Inner pipe

2a Upper part of the inner pipe

2b Lower part of the inner pipe

3a to 3f Inclined steel material

4 Fixing jig

5 Fiber sheet

6 Sheet protective material

7 Outer pipe

7a Upper part of the outer pipe

7b Lower part of the outer pipe

8 Buffer material

9 Cable

10 Space

11 Hollow part of the inclined steel material

1. A protective member for protecting cables, comprising:
an inclined steel material having an upper surface inclined to a horizontal surface above the cable; and
an outer pipe which is a buried pipe for accommodating the cables and the inclined steel material.

2. The protective member according to claim 1, further comprising:
a fiber sheet arranged on an upper surface of the inclined steel material.

3. The protective member according to claim 2, further comprising:
a sheet protective material preventing water absorption of the fiber sheet and covering a surface of the fiber sheet.

4. The protective member according to claim 1, further comprising:
an inner pipe that is a buried pipe for accommodating the cables, wherein
the inclined steel material has an upper surface inclined to the horizontal surface above the inner pipe, and
the outer pipe accommodates the inner pipe.

5. The protective member according to claim 4, wherein
the inclined steel material has a polygonal cross-section and comprises a hollow part for accommodating the inner pipe.

6. The protective member according to claim 4, wherein
the inclined steel material has a chevron-shaped cross section.

7. The protective member according to claim 1, further comprising:
a buffer material arranged between the inclined steel material and the inner pipe.

8. A protective method for protecting the cables, comprising:
arranging the inclined steel material having the upper surface inclined to the horizontal surface above the cable; and
accommodating the cables and the inclined steel material in the outer pipe which is the buried pipe.
